(19) United States
(12) Patent Application Publication
(10) Pub. No.: US 2009/0051975 A1
(43) Pub. Date: Feb. 26, 2009

(54) SHEET TURNAROUND ASSEMBLY

(76) Inventors: Curt A. Wiens, Oakdale, MN (US); Thomas Brace, St. Paul, MN (US)

Correspondence Address: Patent Legal Staff;Carestream Health Inc., 150 Verona Street, Rochester, NY, 14608, US

(21) Appl. No.: 11/843,880

(22) Filed: Aug. 23, 2007

(51) Int. Cl. H04N 1/21; B65H 5/02

(52) U.S. Cl. 358/302; 271/225

(57) ABSTRACT

A sheet turnaround assembly including a drive shaft positioned laterally across a transport path from a processing system, a plurality of drive wheels axially coupled to and positioned in a spaced fashion along the drive shaft, and a plurality of continuous belts, one belt corresponding to each drive wheel. Each belt is positioned so that its outside surface is tensioned against and forms a desired wrap angle about the corresponding drive wheel to create an arcuate turnaround path there between extending between input and output nips formed by initial and final points of contact between the belt and the drive wheel. The sheet turnaround is configured to receive a thermally developed sheet of photothermographic imaging media from a thermal processor at the input nip via the transport path. Rotation of the drive wheels by the drive shaft causes the outside surface of each belt to run along the corresponding drive wheel and drive the developed sheet along and expel the developed sheet from the turnaround path at the output nip to an output device after turning the developed sheet from the transport path by an angle substantially equal to the wrap angle.

### FIELD OF THE INVENTION

The invention relates generally to the field of imaging, and in particular to an imaging apparatus employing a sheet turnaround assembly. More specifically, the invention relates to an imaging apparatus with a sheet turnaround assembly employing drive wheels and belts to introduce a high-degree in a sheet transport path following a processing system.

### BACKGROUND OF THE INVENTION

Light sensitive photothermographic film is used in many applications, ranging from a standard photography apparatus to graphic arts to medical imaging systems. Photothermographic film generally includes a base material, such as a thin polymer or paper, coated generally on one side with an emulsion of heat sensitive material. After the emulsion has been subjected to photostimulation (i.e. exposed), the resulting latent image is developed through application of heat to the film.

Several types of photothermographic imaging systems have been developed. For example, laser imagers are widely used in the medical imaging field to produce visual representations on film of digital image data generated by magnetic resonance (MR), computed tomography (CT), and other types of scanners. Laser imagers typically include a media supply system, a laser exposure system, a processing system, and an output system.

In operation, the media supply system provides a sheet of unexposed photothermographic film along a transport path to the laser exposure unit, which exposes a desired latent image in the emulsion. The exposed sheet is then moved along the transport path to the processing system which develops the exposed sheet though application of heat. The developed sheet is then moved along the transport path to the output system (e.g. a tray or a sorter) for access by a user. To create a compact system, the components of the laser imager are often arranged in a vertical fashion with the media supply system being positioned at the bottom and the output system being positioned on top of the unit. In such systems, a turnaround assembly is often employed to introduce a high degree turn (e.g. 180-degrees) in the transport path and direct the sheet from the processing system to the output system on top of the laser imager.

One conventional turnaround assembly employs at least one curved media guide to form the turn in the transport path. Driven roller pairs are positioned at the leading and trailing edges of the media guide, and sometimes along the length of the turn when multiple media guides are employed, to drive sheets through the turn to the output system. While such turnaround systems are generally effective at turning sheets along the transport path, the sheets can sometimes be scratched as they slide along the media guides and cause undesirable visual artifacts in the image. Additionally, the need for both media guides and driven roller pairs adds cost to the imaging system.

As such, while such systems may have achieved certain degrees of success in their particular applications, there is a need to provide an improved turnaround assembly.

### SUMMARY OF THE INVENTION

An object of the present invention is to provide a cost-effective sheet turnaround assembly that introduces a high-degree turn in a sheet transport path following a processing system without damaging or otherwise causing defects in a developed sheet of imaging media.

Another object of the present invention is to provide a turnaround assembly which does not employ curved media guides for directing sheets of imaging media.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one embodiment, there is provided a sheet turnaround assembly including a drive shaft positioned laterally across a transport path from a processing system, a plurality of drive wheels axially coupled to and positioned in a spaced fashion along the drive shaft, and a plurality of continuous belts, one belt corresponding to each drive wheel. Each belt is positioned so that its outside surface is tensioned against and forms a desired wrap angle about the corresponding drive wheel to create an arcuate turnaround path there between extending between input and output nips formed by initial and final points of contact between the belt and the drive wheel. The sheet turnaround is configured to receive a thermally developed sheet of photothermographic imaging media from a thermal processor at the input nip via the transport path. Rotation of the drive wheels by the drive shaft causes the outside surface of each belt to run along the corresponding drive wheel and drive the developed sheet along and expel the developed sheet from the turnaround path at the output nip to an output device after turning the developed sheet from the transport path by an angle substantially equal to the wrap angle.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a block diagram illustrating generally an example of an imaging apparatus employing a sheet turnaround assembly according to one embodiment.

FIG. 2 shows a perspective view of one embodiment of a sheet turnaround assembly.

FIG. 3 shows a schematic diagram of a cross-sectional view of the sheet turnaround assembly of FIG. 2 according to one embodiment.

FIG. 4 shows a side view of a drive wheel according to one embodiment.

### DETAILED DESCRIPTION OF THE INVENTION

The following is a detailed description of the preferred embodiments of the invention, reference being made to drawings in which the same reference numerals identify the same elements of structure in each of the several figures.

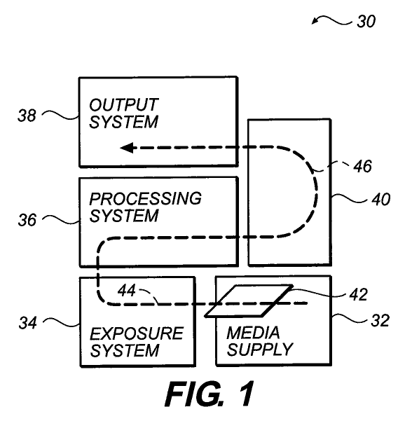

FIG. 1 is a block diagram illustrating generally an example of an imaging apparatus 30 including a turnaround assembly for introducing a high degree turn in a media transport path according to embodiments described herein. In one embodiment, imaging apparatus 30 comprises a medical image reproduction system. Imaging apparatus 30 includes a media supply system 32 containing sheets of unexposed photothermographic imaging media, an exposure system 34, a processing system 36, an output system 38, and a turnaround assembly 40 according to embodiments as will be described in greater detail herein. In one embodiment, media supply system 32 includes one or more media cassettes, each containing a stack of sheets of unexposed photothermographic imaging media, and includes a pickup assembly for removing individual sheets from the cassettes.

In operation, media supply system 32 provides an individual sheet of unexposed photothermographic imaging media, such as sheet 42, along a transport path 44 to exposure system 34. Exposure system 34 subsequently exposes a desired image on sheet 42 based on data representative of the desired image (e.g. digital or analog) to form a latent image of the desired image on sheet 42. In one embodiment, exposure system 34 comprises a laser exposure unit which exposes the latent image on sheet 42 via image data-based modulation of a laser scanning module. Exposed sheet 42 is moved along transport path 44 to processing system 36 which heats exposed sheet 42 to thermally develop the latent image. In one embodiment, processing system 36 comprises a drum and flatbed type thermal processor, such as that described by U.S. patent application Ser. No. 11/029,592. Turnaround assembly 40 receives and drives developed sheet 42 from transport path 44 along an arcuate turnaround path 46 so as to provide a high-degree turn and expel developed sheet 42 to output system 38, which receives and stores one or more developed sheets for access by a user of imaging apparatus 30. An example of an imaging apparatus similar to that described above by imaging apparatus 30 and suitable to be configured for use with output system 38 according to embodiments of the present invention is described by U.S. Pat. No. 6,007,971 to Star et al., which is herein incorporated by reference.

As will be described in greater detail below, according to one embodiment, turnaround assembly 40 includes a driven shaft positioned laterally across transport path 44, a plurality of drive wheels are axially coupled to and positioned in a spaced fashion along the drive shaft, and a plurality of belts, one belt corresponding to each drive wheel. Each belt is positioned so that its outside surface is tensioned against and forms a desired wrap angle about the corresponding drive wheel to create arcuate turnaround path 46 there between and which extends between input and output nips formed by initial and final points of contact between the belt and the drive wheel.

Turnaround assembly 40 is configured to receive a sheet at the input nip from transport path 44. Rotation of the drive wheels by the driven shaft causes the outside surface of each belt to travel along the corresponding drive wheel and drive the sheet along arcuate turnaround path 46 from the input nip to the output nip, where the sheet is expelled from turnaround assembly 40, such as to output system 39, for example. As such, turnaround assembly is configured to turn and redirect a sheet from the transport path by an angle substantially equal to the wrap angle of the belts about their corresponding drive wheel.

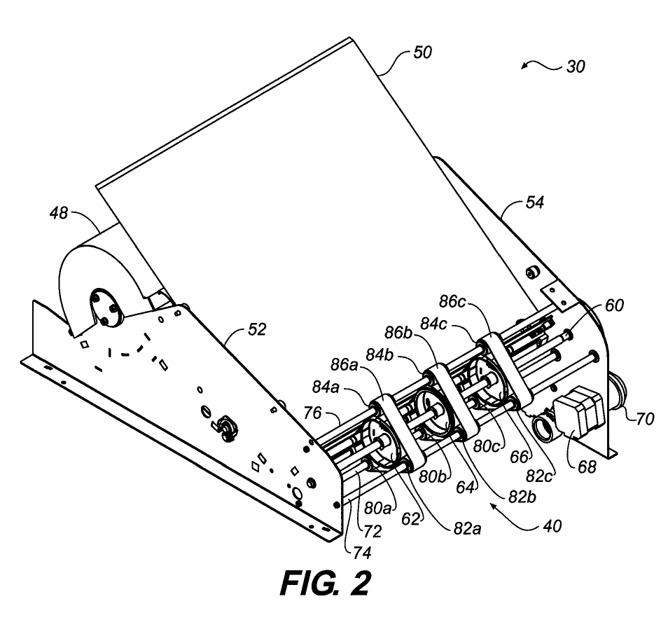

FIG. 2 is a perspective view illustrating one embodiment of turnaround assembly 40 as installed in an example embodiment of imaging apparatus 30. For illustrative clarity, only portions of imaging apparatus 30 are illustrated in FIG. 2, including a drum type processor 48 forming a portion of processing system 36, an output tray 50 forming a portion of output system 38, and endplates 52 and 54 forming a portion of a frame or housing of imaging apparatus 30.

Turnaround assembly 40 includes a drive shaft 60 which is rotatably coupled between endplates 52 and 54 and positioned laterally across and substantially parallel to transport path 44 extending at least from drum type processor 48 to turnaround assembly 40. Drive wheels 62, 64, and 66 are coupled to and positioned in a spaced fashion along drive shaft 60 and, thus, in a spaced fashion relative to transport path 44. A motor 68 is coupled to and drives drive shaft 60 via a drive belt 70.

In one embodiment, as illustrated by FIG. 2, three stationary idler shafts 72, 74, and 76 are coupled between endplates 52 and 54 and are radially-spaced about drive shaft 60. Idler wheels 80a, 80b, and 80c are rotatably mounted to and free to spin about idler shaft 72 and are spaced so as to respectively align and be coplanar with drive wheels 62, 64, and 66. Idler wheels 82a, 82b, and 82c are rotatably mounted to and free to spin about idler shaft 74 and are spaced so as to respectively align an be coplanar with drive wheels 62, 64, and 66. Idler wheels 84a, 84b, and 84c are rotatably mounted to and free to spin about idler shaft 76 and are spaced so as to respectively align and be coplanar with drive wheels 62, 64, and 66.

A continuous turnaround belt 86a is stretched and looped about idler wheels 80a, 82a, and 84a such that an inside surface contacts and rides on idler wheels 80a, 82a, and 84a and an outside surface wraps around a portion of and rides on drive wheel 62. Similarly, a continuous turnaround belt 86b is stretched and looped about idler wheels 80b, 82b, and 84b such that an inside surface contacts and rides on idler wheels 80b, 82b, and 84b and an outside surface wraps around a portion of and rides on drive wheel 64, and a continuous turnaround belt 86c is stretched and looped about idler wheels 80c, 82c, and 84c such that an inside surface contacts and rides on idler wheels 80c, 82c, and 84c and an outside surface wraps around a portion of and rides on drive wheel 64.

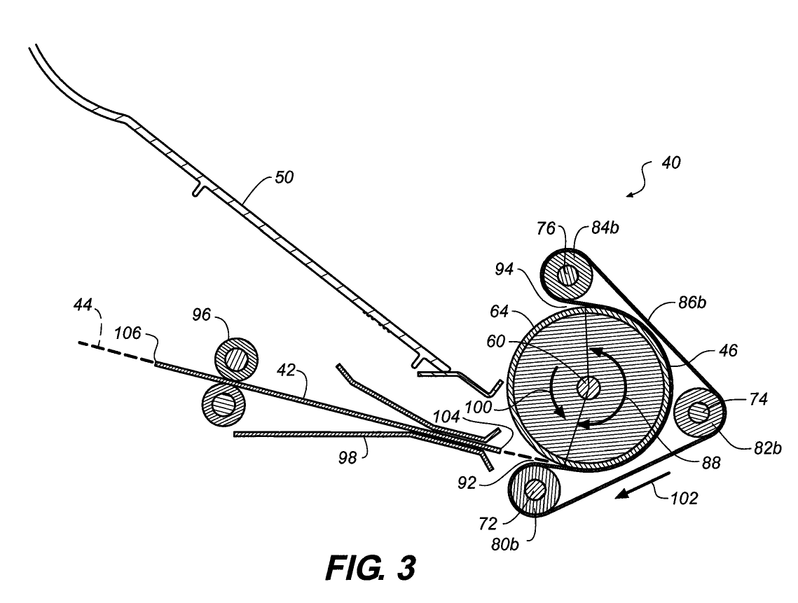

FIG. 3 is a schematic diagram illustrating a cross-sectional view of turnaround assembly 40 and portions of imaging apparatus 30. Although FIG. 3 illustrates a cross-sectional view through center drive wheel 64 and corresponding turnaround belt 86b and idler wheels 80b, 82b, and 84b, FIG. 3 and the associated description applies similarly to outside drive wheels 62 and 64 and associated idler wheels 80a, 82a, 82a, 80c, 82c, 84c and turnaround belts 86a and 86c.

As illustrated by FIG. 3, idler shafts 72, 74, and 76 and corresponding idler wheels 80b, 82b, and 84b are positioned radially about and co-planar with drive wheel 64 such that when associated turnaround belt 86b is stretched about idler wheels 80b, 82b, and 84b such that the outside surface of turnaround belt 86b is tensioned against and forms a desired wrap angle 88 about drive wheel 64. By tensioning turnaround belt 86b against drive wheel 64 in this fashion, the outside surface of turnaround belt 86b and drive wheel 64 together form arcuate turnaround path 46 extending between an input nip 92 and an output nip 94 respectively formed by initial and final points of contact between turnaround belt 86b and drive wheel 64.

In operation, motor 68, via drive belt 70 and drive shaft 60, turns drive wheel 64 (and also drive wheels 62 and 66) in a direction as indicated by rotational arrow 100. Because of the tensioning of turnaround belt 86b against drive wheel 64, as drive wheel 64 is driven, the outside surface of turnaround belt 86b moves with drive wheel 64 and turnaround belt 86b is driven in a loop about idler wheels 80b, 82b, and 84b, as indicated by directional arrow 102, with idler wheels 80b, 82b, and 84b respectively spinning about corresponding stationary idler shafts 72, 74, and 76.

In one embodiment, transport path 44 of processing system 36 is formed, at least in part, by a pair of output nip rollers 96 and a media guide 98. Input nip 92 is positioned so as to receive developed sheet 42 from transport path 44 via media guide 98. When a developed sheet of imaging media, such as developed sheet 42, is received from transport path 44, the rotation of drive wheel 64 and turnaround belt 86b draws a leading edge 104 of developed sheet 42 into input nip 92 and drives developed sheet 42 along arcuate turnaround path 46 until a trailing edge 106 is expelled from output nip 94 and developed sheet 42 is delivered to output tray 50.

By engaging and transporting developed sheet 42 along arcuate turnaround path 46 in this fashion, turnaround assembly 40 turns developed sheet 42 by a turnaround angle relative to transport path 44 which is substantially equal to desired wrap angle 88. In one embodiment, idler shafts 72, 74, and 76 and corresponding idler wheels 80b, 82b, and 84b are positioned so that turnaround belt 86b forms a desired wrap angle 88 of at least 120-degrees about drive wheel 64. In one embodiment, turnaround belt 86b forms a desired wrap angle 88 greater than 180-degrees.

In one embodiment, while developed sheet 42 is engaged by output nip rollers 96 of processing system 36, motor 68 turns drive wheels 62, 64, and 66 at a first transport rate which is substantially equal to the transport rate of output nip rollers 96. Subsequently, after trailing edge 106 of developed sheet 42 has passed through output nip rollers 96, motor 68 turns drive wheels 62, 64, and 66 at a second transport rate which is greater than the first transport rate.

In one embodiment, sheet 42 comprises a photothermographic film having an image side (e.g. an emulsion of heat sensitive material) which contacts the outside surface of turnaround belt 86b as developed sheet 42 travels along arcuate transport path 46 from input nip 92 to output nip 94. In one embodiment, turnaround belt 86b (and turnaround belts 86a and 86c) is formed with its outside surface as smooth as possible so as not to scratch or otherwise damage (e.g. cause indentations) the image or emulsion side of developed sheet 42.

In one embodiment, turnaround belt 86b is a seamless belt. In one embodiment, turnaround belt 86b is formed from a urethane material using spin-casting techniques. In one embodiment, turnaround belt 86b is formed so at to have anti-static properties. In one embodiment, turnaround belt 86b is formed with anti-static particles, such as carbon particles, in the urethane material. By having anti-static properties, artifact causing debris is less likely to cling to and accumulate on the outer surface of turnaround belt 86b.

Additionally, it is noted that if turnaround belt 86b is stretched too far, the tension of turnaround belt 86b against drive wheel 64 may be too great and cause defects (e.g. indentations) in developed sheet 42. However, if not stretched far enough, turnaround belt 86b may not provide enough tension against drive wheel 64 to adequately engage developed sheet 42. In one embodiment, turnaround belt 86b has a stretched length which is within a range that is between 1% and 8% greater than its unstretched or relaxed length. In one embodiment, turnaround belt 86b has a stretched length of approximately 385 millimeters and a relaxed length of approximately 372 millimeters (i.e. approximately 3.5% greater).

In one embodiment, idler wheels 80a-80c, 82a-82c, and 84a-84c are retained within corresponding grooves in stationary idler shafts 72, 74, and 76. In one embodiment, idler wheels 80a-80c, 82a-82c, and 84a-84c are formed using an anti-static acetal material. In one embodiment, idler wheels 80a-80c, 82a-82c, and 84a-84c are crowned so that corresponding turnaround belts 86a-86c track and remain centered on idler wheels 80a-80c, 82a-82c, and 84a-84c and on drive wheels 62, 64, and 66. An example of an idler wheel and idler shaft suitable to be configured for use as idler wheels 80a-80c, 82a-82c, and 84a-84c and idler shafts 72, 74, and 76 is described by U.S. patent application Ser. No. 11/502,095 and entitled “Idler Wheel Assembly”, which is assigned to the same assignee as the present invention and incorporated herein by reference.

Although FIG. 2 and FIG. 3 above describe turnaround belts 86a-86c as being stretched about and riding on a corresponding set of idler wheels and associated idler shafts, turnaround belts 86a-86c may be supported by other suitable methods, such as by three or more idler rollers, for example, with each idler roller supporting each of the turnaround belts 86a-86c. However, as opposed to idler rollers, idler wheels independently spinning about idler shafts, as described above, enable independent movement of turnaround belts 86a-86c.

In one embodiment, drive wheels 62, 64, and 66 are formed or molded from a plastic material. In one embodiment, drive wheels 62, 64, and 66 are molded from an anti-static acetal material. In one embodiment, the circumference of center drive roller 64 is covered or coated with a rubber material so as to better engage and drive developed sheet 42.

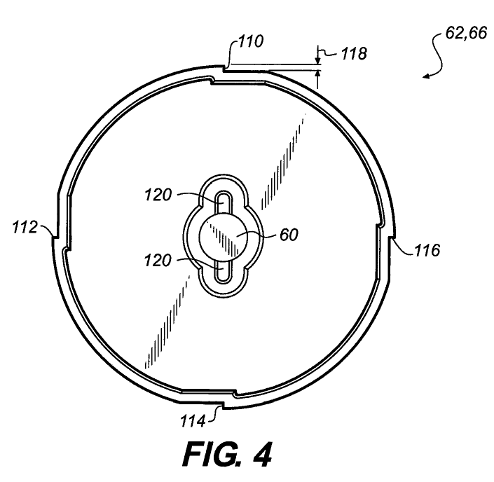

FIG. 4 is side view of one embodiment of outside drive wheels 62 and 66. In one embodiment, while center drive wheel 64 is covered or coated with a rubber material, the circumference of outside drive wheels 62 and 66 are uncoated and include one or more “kick” notches which engage trailing edge 106 of developed sheet 42 as drive wheels 62 and 66 rotate so as to push/expel developed sheet 42 from output nip 94 and into output tray 50. In one embodiment, as illustrated by FIG. 4, outside drive wheels 62 and 66 include four kick notches, indicated as kick notches 110, 112, 114, and 116 which are positioned at 90-degree intervals along the circumference. In one embodiment, each of the kick notches 110, 112, 114, and 116 has a depth of approximately 1 millimeter, as indicated at 118. In one embodiment, outside drive wheels 62 and 66 include a key slot 120 such that the kick notches of outside drive wheels 62 and 66 align with one another after installation on drive shaft 60.

Although illustrated by FIG. 2 and FIG. 3 as employing three drive wheels 62, 64, and 66, it is noted that turnaround assembly 40 may employ more or fewer than three drive wheels. Additionally, although illustrated as employing three idler shafts 72, 74, and 76 and a set of three idler wheels corresponding to each drive wheel, such as idler wheels 80a, 82a, and 84a corresponding to drive wheel 62, it is noted that turnaround assembly 40 may employ more than three idler shafts and a set of more than three idler wheels corresponding to each drive wheel (e.g. four idler wheels per drive wheel).

In summary, by employing turnaround belts 86a-86c tensioned against and traveling over drive wheels 62-66, as described above, turnaround assembly 40 introduces a high-degree turn in the sheet transport path to direct a developed sheet of imaging media from a processing system to an output system without employing curved media guides. As such, turnaround assembly 40 provides a high-degree turn to a developed sheet of imaging media without introducing scratches or other defects associated with guide plates, thereby improving image quality. Turnaround assembly 40 is also cost effective, as guide plates are not required, and is lighter in weight relative to turnaround assemblies employing roller pairs and guide plates.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

PARTS LIST

| | |
|---|---|
| 30 | Imaging Apparatus |
| 32 | Media Supply System |
| 34 | Exposure System |
| 36 | Processing System |
| 38 | Output System |
| 40 | Turnaround Assembly |
| 42 | Sheet of Imaging Media |
| 44 | Transport Path |
| 46 | Turnaround Path |
| 48 | Drum Processor |
| 50 | Output Tray |
| 52 | Endplate |
| 54 | Endplate |
| 60 | Drive Shaft |
| 62 | Drive Wheel |
| 64 | Drive Wheel |
| 66 | Drive Wheel |
| 68 | Motor |
| 70 | Belt |
| 72 | Idler Shaft |
| 74 | Idler Shaft |
| 76 | Idler Shaft |
| 80a | Idler Wheel |
| 80b | Idler Wheel |
| 80c | Idler Wheel |
| 82a | Idler Wheel |
| 82b | Idler Wheel |
| 82c | Idler Wheel |
| 84a | Idler Wheel |
| 84b | Idler Wheel |
| 84c | Idler Wheel |
| 86a | Turnaround Belt |
| 86b | Turnaround Belt |
| 86c | Turnaround Belt |
| 88 | Wrap Angle |
| 92 | Input Nip |
| 94 | Output Nip |
| 96 | Nip Rollers |
| 98 | Media Guide |
| 100 | Rotational Arrow |
| 102 | Directional Arrow |
| 104 | Leading Edge |
| 106 | Trailing Edge |
| 110 | Kick Notch |
| 112 | Kick Notch |
| 114 | Kick Notch |
| 116 | Kick Notch |
| 118 | Kick Notch Depth |
| 120 | Key Slot |

What is claimed is:

1. A sheet turnaround comprising:
a drive shaft positioned laterally across a transport path from a processing system;
a plurality of drive wheels axially coupled to and positioned in a spaced fashion along the drive shaft; and
a plurality of continuous belts, one belt corresponding to each drive wheel, wherein each belt is positioned so that its outside surface is tensioned against and forms a desired wrap angle about the corresponding drive wheel to create an arcuate turnaround path there between extending between input and output nips formed by initial and final points of contact between the belt and the drive wheel, wherein the sheet turnaround is configured to receive a thermally developed sheet of photothermographic imaging media from a thermal processor at the input nip via the transport path, and wherein rotation of the drive wheels by the drive shaft causes the outside surface of each belt to run along the corresponding drive wheel and drive the developed sheet along and expel the sheet from the turnaround path at the output nip to an output device after turning the developed sheet from the transport path by an angle substantially equal to the wrap angle.

2. The sheet turnaround assembly of claim 1, wherein each belt comprises a seamless belt.

3. The sheet turnaround assembly of claim 1, wherein each belt comprises a urethane material.

4. The sheet turnaround assembly of claim 1, where each belt is formed so as to have anti-static properties.

5. The sheet turnaround assembly of claim 4, wherein each belt includes anti-static particles.

6. The sheet turnaround assembly of claim 1, wherein each belt is tensioned by stretching the belt by a desired amount.

7. The sheet turnaround assembly of claim 6, wherein each belt is stretched so as to have a stretched length which is in a range from one to eight percent greater than a relaxed length.

8. The sheet turnaround assembly of claim 1, wherein the desired wrap angle is at least 120-degrees.

9. The sheet turnaround assembly of claim 1, wherein at least one of the drive wheels has a circumference which is covered with a rubber material.

10. The sheet turnaround assembly of claim 1, wherein one or more of the drive wheels includes at least one kick notch along the circumference configured to engage a trailing edge of the sheet and expel the sheet from the output nip as the drive wheels rotate.

11. The sheet turnaround assembly of claim 1, wherein the plurality of drive wheels comprises three drive wheels, including a center drive wheel and two outside drive wheels, wherein the center drive wheel has a circumference coated with a rubber material and the outside drive wheels each include at least one kick notch along the circumference configured to engage a trailing edge of the sheet and expel the sheet from the output nip as the drive wheels rotate.

12. The sheet turnaround assembly of claim 1, including:
a plurality of idler wheel sets, one set corresponding to each drive wheel and including at least three idler wheels radially spaced from and coplanar with the corresponding drive wheel, wherein the belt associated with each drive wheel is stretched about the at least three idler wheels of the corresponding idler wheel set such that an inside surface of the belts rides on the idler wheels and the outside surface rides on the drive wheel.

13. The sheet turnaround assembly of claim 12, wherein the at least three idler wheels of each set are positioned so that the outside surface of the associated drive belt contacts and forms the desired wrap angle about the corresponding drive wheel.

14. The sheet turnaround assembly of claim 12, wherein the idler wheels of each set of idler wheels which are at a same radial position relative to the drive wheels are mounted on a same idler shaft, the idler shaft being positioned in parallel with the drive shaft.

15. A laser imaging system comprising:
a processing system configured to provide a developed sheet of photothermographic imaging media along a transport path; and
a turnaround assembly including:
a drive shaft positioned laterally across a transport path from a processing system;
a plurality of drive wheels axially coupled to and positioned in a spaced fashion along the drive shaft; and
a plurality of belts, one belt corresponding to each drive wheel, wherein each belt is positioned so that its outside surface is tensioned against and forms a desired wrap angle about the corresponding drive wheel to create an arcuate turnaround path there between extending between input and output nips formed by initial and final points of contact between the belt and the drive wheel, wherein the turnaround assembly is configured to receive the developed sheet at the input nip, and wherein rotation of the drive wheels by the drive shaft causes the outside surface of each belt to run along the corresponding drive wheel and drive the developed sheet along and expel the developed sheet from the turnaround path at the output nip to an output system after turning the developed sheet from the transport path by an angle substantially equal to the desired wrap angle.

16. The laser imaging system of claim 15, wherein the desired wrap angle is at least equal to 120-degrees.

17. The laser imaging system of claim 15, wherein the turnaround assembly is configured to transport the developed sheet at a first transport rate which is substantially equal to a transport rate of the processing system while a trailing edge of the developed sheet is engaged by the processing system, and to transport the developed sheet at a second transport rate which is greater than the first transport after the trailing edge of the sheet exits the processing system.

18. The laser imaging system of claim 15, wherein the belts comprise seamless belts.

19. The laser imaging system of claim 18, wherein the belts are formed from an anti-static acetal material using spin-casting techniques.

20. A method for transporting a developed sheet of thermally developed photothermographic imaging media from a processing unit to an output of an imaging apparatus, the method comprising:
tensioning a plurality of continuous belts against a corresponding plurality of drive wheels such that an outside surface of each belt wraps around the corresponding drive wheel by a desired wrap angle to form an arcuate turnaround path between the outside surface and the drive wheel which extends between input and output nips formed by initial and final points of contact between the belt and drive wheel;
driving the drive wheels so cause the outside surface of each belt to move along the circumference of the corresponding drive wheel between the input and output nips; and
receiving a developed sheet of imaging media at the input nip, wherein rotation of the drive wheels and movement of the corresponding belts drives the sheet of developed imaging media along the arcuate turnaround path and expels the sheet of developed imaging media from the output nip.

21. The method of claim 20, wherein tensioning the plurality of continuous belts includes stretching the belts such that each belt such that stretched length is in a range between one and eight percent greater than a relaxed length.
